(19) United States
(12) Patent Application Publication
(10) Pub. No.: US 2017/0340107 A1
(43) Pub. Date: Nov. 30, 2017

(54) SINGLE DOVETAIL TENON JOINT MECHANISM

(71) Applicant: Jian Shen, Mansfield, MA (US)

(72) Inventor: Jian Shen, Mansfield, MA (US)

(21) Appl. No.: 15/219,362

(22) Filed: Jul. 26, 2016

(30) Foreign Application Priority Data
May 25, 2016 (CN) 201620484006.5

(51) Int. Cl. A47B 47/04; F16B 12/12; F16B 12/46

(52) U.S. Cl. CPC A47B 47/042; F16B 12/46; F16B 12/125; F16B 2012/466

(57) ABSTRACT

A single dovetail tenon joint mechanism has a first panel and a second panel; the first panel is provided with a single dovetail tenon groove; the cross-section of the single dovetail tenon groove is a right-angled trapezoid; the right-angle sides of the right-angled trapezoid are near the edge side of the first panel; the long base of the right-angled trapezoid is located at the deepest part of the single dovetail tenon groove; one end of the second panel is provided with a single dovetail tenon that matches the single dovetail tenon groove. The single dovetail tenon is wedged into the single dovetail tenon groove for attachment therewith. During installation, a single dovetail tenon can be inserted from one end of the single dovetail tenon groove, thereby attaching the first panel to the second panel.

### TECHNICAL FIELD

The present Invention relates to the technical field of woodworking techniques, in particular to a joint mechanism.

### BACKGROUND OF THE INVENTION

With most of the cupboards and cabinets available on the market, screws, rivets, three-in-one connecting pieces, etc. are used as assembly parts for the connection between panels. Although they are easy to assemble and disassemble, their structures are not stable or strong enough. In addition, after being exposed to a humid environment for a long time, screws and rivets get rusty; moreover, due to changes in the climate and temperature, boards bend and become deformed.

For a double dovetail joint structure, the technique is complex; in addition, because the grooves that need to be made are deep and there are many of them, the strength decreases. Moreover, too much wood needs to be set aside for the edges.

### SUMMARY OF THE INVENTION

The present Invention is intended to provide a single dovetail tenon joint mechanism in order to solve at least one of the aforesaid technical problems. With the present Invention, the technical problems can be solved by adopting the following technical solution:

A single dovetail tenon joint mechanism, comprising a first panel and a second panel, is characterized in that the first panel is provided with a single dovetail tenon groove; the cross-section of the single dovetail tenon groove is a right-angled trapezoid; the right-angle sides of the right-angled trapezoid are near the edge side of the first panel; the long base of the right-angled trapezoid is located at the deepest part of the single dovetail tenon groove; one end of the second panel is provided with a single dovetail tenon that matches said single dovetail tenon groove. For the various panel arrangements refer to FIG. 11 showing panel 1 with end grooves; panels 2 with a groove at one end and a tendon at the opposite end; and panel 5 with tendons on opposed ends.

The single dovetail tenon is wedged into said single dovetail tenon groove for attachment therewith. During installation, a single dovetail tenon can be inserted from one end of the single dovetail tenon groove, thereby attaching the first panel to the second panel. Regarding the engagement between the panels refer to FIGS. 4, 11 and 12, in particular FIG. 12 illustrating panels 2 slid in the direction of arrow A, engaging with panel 1.

The single dovetail tenon joint mechanism makes cupboard or cabinet installations easy and the technique is convenient, allowing a decrease in the distance reserved for the outer edge of a panel. Thus, a cabinet that adopts this single dovetail tenon joint mechanism can have a large inner space and is aesthetically pleasing.

The cross-section of said single dovetail tenon is a right-angled trapezoid; the long base of said right-angled trapezoid is located on the end face of the second panel. When joined together, the long base, the right-angle sides, and the hypotenuse of the right-angled trapezoid of said single dovetail tenon respectively fit the long base, the right-angle sides, and the hypotenuse of said right-angled trapezoid of said single dovetail tenon groove.

One side of said first panel can be provided with a single dovetail tenon groove, and the opposite other end can be provided with said single dovetail tenon. One side of said first panel can be provided with a single dovetail tenon groove, and the opposite other side can also be provided with said single dovetail tenon groove. One end of said first panel can be provided with a single dovetail tenon, and the opposite other end can also be provided with said single dovetail tenon. One side of said second panel can be provided with a single dovetail tenon groove, and the opposite other end can be provided with said single dovetail tenon. One side of said second panel can be provided with a single dovetail tenon groove, and the opposite other side can also be provided with said single dovetail tenon groove. One end of said second panel is provided with a single dovetail tenon, and the opposite other end can also be provided with said single dovetail tenon.

Said first panel can be used in a face frame for a cabinet. Said second panel can be used as a side board for the cabinet. At least two first panels and two second panels can be arranged to form the frame of the cabinet. The depth of said single dovetail tenon groove is in the range 5 mm-9 mm, preferably 7 mm. The included angle between the hypotenuse and the long base of said right-angled trapezoid is in the range of 70 degrees-76 degrees, preferably 74 degrees.

The present Invention provides the following beneficial effects: The single dovetail tenon joint mechanism makes cabinet installations easy and the technique is convenient, thus allowing for a decrease in the distance reserved for the outer edge of a panel. Thus, a cabinet that adopts this single dovetail tenon joint mechanism can have a large inner space and is aesthetically pleasing. In addition, when the right-angle sides of the single dovetail tenon groove fit the right-angle sides of the single dovetail tenon, the gaps are small, and thus it is easy to paint the resulting structure.

### BRIEF DESCRIPTION OF THE DRAWINGS

It should be understood that the drawings are provided for the purpose of illustration only and are not intended to define the limits of the disclosure. The foregoing and other objects and advantages of the embodiments described herein will become apparent with reference to the following detailed description when taken in conjunction with the accompanying drawings in which:

FIG. 1 shows a schematic drawing of a structure of the present Invention.

FIG. 2 shows a schematic drawing of part of the structure of the present Invention.

FIG. 3 shows a schematic drawing of part of the structure of the present Invention.

FIG. 4 is a perspective view of the structure of the present Invention.

FIG. 5 is a fragmentary view at the dovetail joint.

FIG. 6 is a top view.

FIG. 7 is a bottom view.

FIG. 8 is a partial perspective view showing one panel engaging with another.

FIG. 9 is a cross-sectional view taken along line 9-9 of FIG. 8.

FIG. 10 is an exploded view of the panels.

FIG. 11 is a more complete cabinet employing the panels and illustrating the various panel forms.

FIG. 12 illustrated engagement between the panels in forming a cabinet.

### DETAILED DESCRIPTION

In order to make it easy to understand the technical means, the novel characteristics, the achieved object, and the effects of the present Invention, the following describes the invention in further detail in conjunction with the drawings.

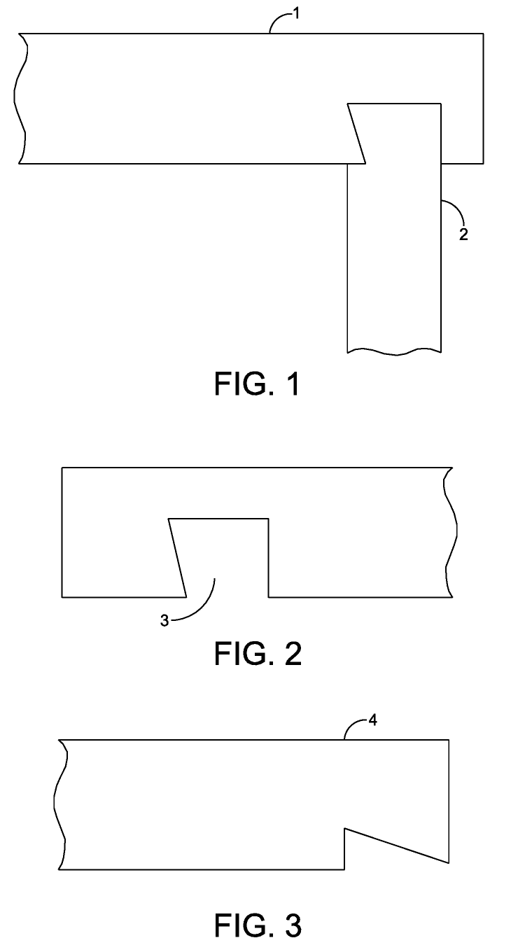

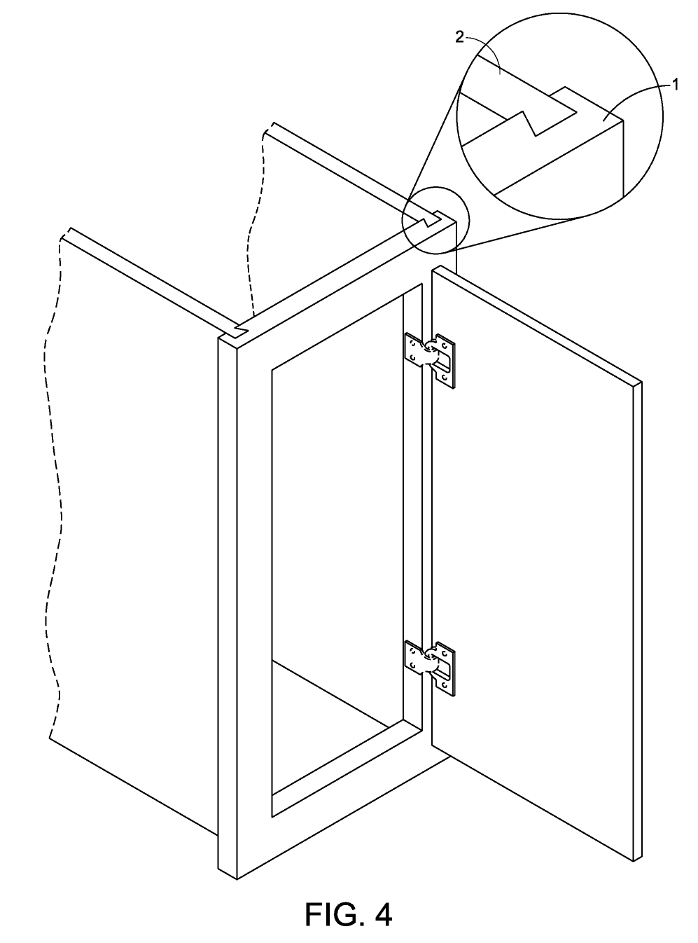

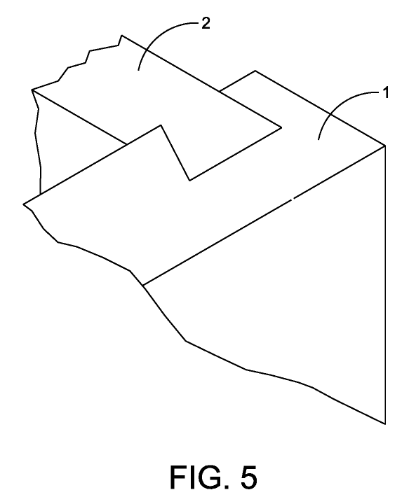

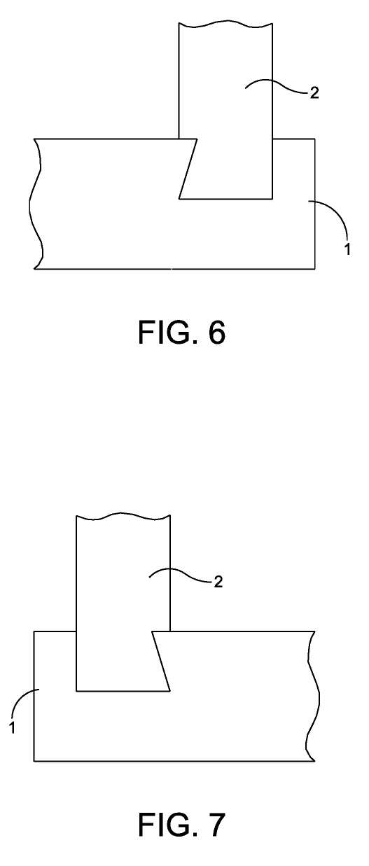

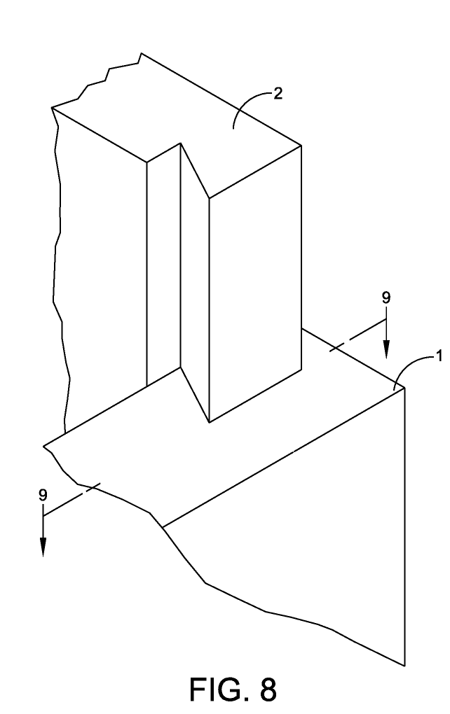

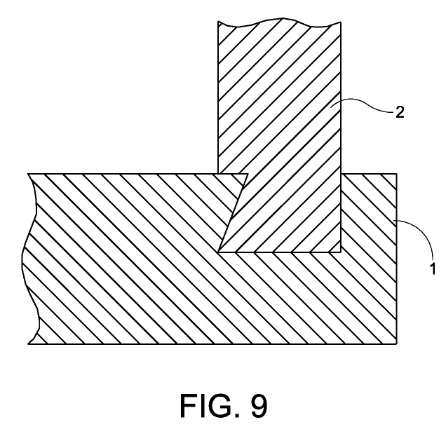

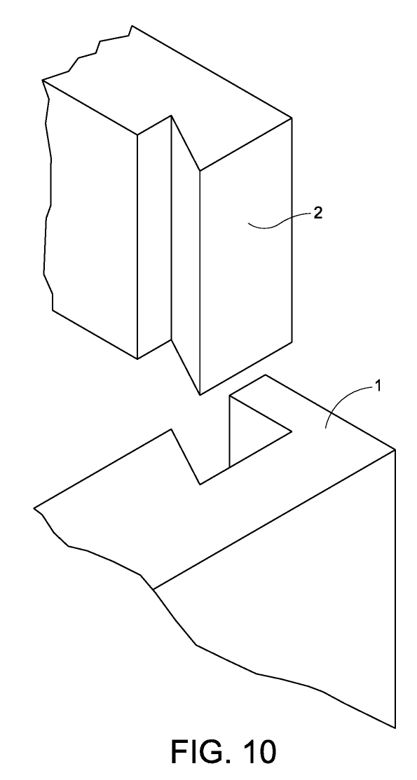

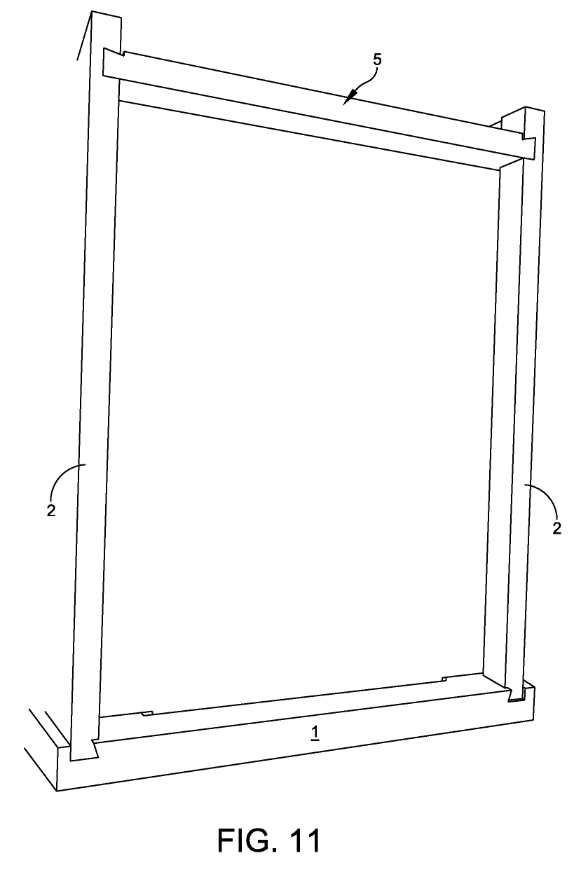

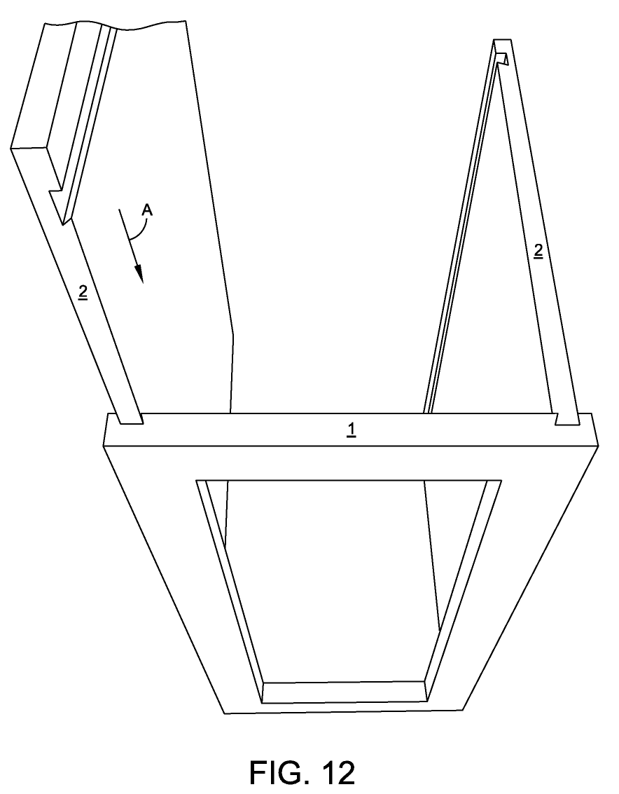

As shown in FIG. 1, FIG. 2, and FIG. 3, the single dovetail tenon joint mechanism comprises a first panel 1 and a second panel 2; the first panel 1 is provided with a single dovetail tenon groove 3; the cross-section of the single dovetail tenon groove 3 is a right-angled trapezoid; the right-angle sides of the right-angled trapezoid are near the edge side of said first panel; the long base of the right-angled trapezoid is located at the deepest part of said single dovetail tenon groove; one end of the second panel 2 is provided with a single dovetail tenon 4 that matches the single dovetail tenon groove 3. The single dovetail tenon 4 is wedged into the single dovetail tenon groove 3 for attachment therewith. During installation, the single dovetail tenon 4 can be inserted from one end of the single dovetail tenon groove 3, thereby attaching the first panel 1 to the second panel 2.

The single dovetail tenon joint mechanism makes cabinet installations easy and the technique is convenient, allowing a decrease in the distance reserved for the outer edge of a panel. Thus, a cabinet that adopts this single dovetail tenon joint mechanism can have a large inner space and is aesthetically pleasing.

The cross-section of the single dovetail tenon 4 is a right-angled trapezoid; the long base of the right-angled trapezoid is located on the end face of the second panel 2. When joined together, the long base, the right-angle sides, and the hypotenuse of the right-angled trapezoid of the single dovetail tenon 4 respectively fit the long base, the right-angle sides, and the hypotenuse of the right-angled trapezoid of the single dovetail tenon groove 3.

One side of the first panel can be provided with a single dovetail tenon groove, and the opposite other end can be provided with a single dovetail tenon. One side of the first panel can be provided with a single dovetail tenon groove, and the opposite other side can also be provided with a single dovetail tenon groove. One end of the first panel can be provided with a single dovetail tenon, and the opposite other end can also be provided with a single dovetail tenon. One side of the second panel can be provided with a single dovetail tenon groove, and the opposite other end can be provided with a single dovetail tenon. One side of the second panel can be provided with a single dovetail tenon groove, and the opposite other side can also be provided with a single dovetail tenon groove. One end of the second panel can be provided with a single dovetail tenon, and the opposite other end can also be provided with a single dovetail tenon.

The first panel can be used in a face frame for the cabinet. The second panel can be used as a side board for the cabinet. At least two first panels and two second panels can be arranged to form the frame of the cabinet. The depth of the single dovetail tenon groove is in the range of 5 mm-9 mm, preferably 7 mm. The included angle between the hypotenuse and the long base of the right-angled trapezoid is in the range of 70 degrees-76 degrees, preferably 74 degrees.

The present Invention provides the following beneficial effects: The single dovetail tenon joint mechanism makes cabinet installations easy and processing is convenient, allowing for a decrease in the distance reserved for the outer edge of a panel. Thus, a cabinet that adopts this single dovetail tenon joint mechanism can have a large inner space and is aesthetically pleasing.

While the basic principles, the main characteristics, and the beneficial effects of the present Invention have been particularly described and shown above, it should be understood that the aforesaid embodiments are not intended to limit the present Invention and that persons of ordinary skill in the art can make various modifications and improvements without departing from the technical scope of the present Invention. These modifications and improvements should also be considered to fall into the protective scope of the present Invention. The technical scope of protection of the present Invention should be defined by the appended claims and equivalents thereof.

What is claimed is:

1. A single dovetail tenon joint mechanism, comprising a first panel and a second panel, is characterized in that the first panel is provided with a single dovetail tenon groove; the cross-section of the single dovetail tenon groove is a right-angled trapezoid; the right-angle sides of the right-angled trapezoid are near the edge side of the first panel; the long base of the right-angled trapezoid is located at the deepest part of the single dovetail tenon groove; one end of the second panel is provided with a single dovetail tenon that matches said single dovetail tenon groove.

2. The single dovetail tenon joint mechanism according to claim 1, further characterized in that the cross-section of said single dovetail tenon is a right-angled trapezoid; the long base of said right-angled trapezoid is located on the end face of the second panel.

3. The single dovetail tenon joint mechanism according to claim 1, further characterized in that the long base, the right-angle sides, and the hypotenuse of the right-angled trapezoid of said single dovetail tenon respectively fit the long base, the right-angle sides, and the hypotenuse of said right-angled trapezoid of said single dovetail tenon groove.

4. The single dovetail tenon joint mechanism according to claim 1, further characterized in that one side of said first panel is provided with a single dovetail tenon groove, and the opposite other end is provided with said single dovetail tenon.

5. The single dovetail tenon joint mechanism according to claim 1, further characterized in that one side of said first panel is provided with a single dovetail tenon groove, and the opposite other side is also provided with said single dovetail tenon groove.

6. The single dovetail tenon joint mechanism according to claim 1, further characterized in that one end of said first panel is provided with a single dovetail tenon, and the opposite other end is also provided with said single dovetail tenon.

7. The single dovetail tenon joint mechanism according to claim 1, further characterized in that a depth of said single dovetail tenon groove is one of in a range of 5 mm-9 mm, and at 7 mm.

8. (canceled)

9. The single dovetail tenon joint mechanism according to claim 1, further characterized in that an included angle between a hypotenuse and a long base of said right-angled trapezoid is in one of a range of 70 degrees-76 degrees, and at 74 degrees.

10. (canceled)

11. A cabinet structure, comprising a first panel including opposed ends thereof and having a single dovetail groove at one end thereof, and a second panel including opposed ends with one end thereof having a single dovetail tenon that matches in shape the single dovetail groove in the first panel, wherein the cross-section of the single dovetail tenon groove of the first panel is a right-angled trapezoid having a right-angled side, wherein the cross-section of the single dovetail tenon of the second panel is a matching right-angled trapezoid having a right-angled side, and wherein the single dovetail tenon matches with the single dovetail groove by a sliding engagement.

12. The cabinet structure according to claim 11, wherein the opposed ends of the first panel have respective end surfaces, and the right-angle side of the right-angled trapezoid of the single dovetail groove is arranged adjacent to the end surface of the first panel.

13. The cabinet structure according to claim 12, wherein the single dovetail groove of the first panel has a long base and the long base of the right-angled trapezoid is located at the deepest part of the single dovetail groove.

14. The cabinet structure according to claim 13 wherein the long base, the right-angle side, and the hypotenuse of the right-angled trapezoid of the single dovetail tenon respectively fit the long base, the right-angle side, and the hypotenuse of the right-angled trapezoid of the single dovetail groove.

15. The cabinet structure according to claim 11 including a pair of second panels each having opposed ends and each including a single dovetail tenon that matches in shape the single respective dovetail grooves in the first panel.

16. The cabinet structure according to claim 14, wherein each of the second panels has at an opposite end thereof a single dovetail groove disposed in a side surface of the second panel, and further including a third panel disposed parallel to the first panel and having respective end dovetail tenons engageable with respective facing single dovetail grooves of the respective pair of second panels.

17. A cabinet comprising at least a first flat panel that forms a face panel of the cabinet, said first flat panel having opposite ends and an inwardly facing surface defining an inner wall surface of the cabinet, and a pair of second flat panels that form respective side panels of the cabinet, said second panels having opposite respective one and another ends, said first flat face panel having respective single dovetail grooves at the opposite ends of the first flat panel, and both respective single dovetail grooves being disposed in the inwardly facing surface defining the inner wall surface of the cabinet, and each said second panel having at one end thereof a single dovetail tendon that matches in shape the single dovetail groove of respective single dovetail grooves at opposed ends of the first panel.

18. The cabinet according to claim 17, wherein the opposed ends of the first panel have respective end surfaces, and the right-angle side of the right-angled trapezoid of the single dovetail groove is arranged adjacent to the end surface of the first panel, and the single dovetail grooves also have non-right-angled portions disposed inwardly of end surfaces of the first panel.

19. The cabinet according to claim 18, wherein each of the single dovetail grooves of the first panel has a long base and the long base of the right-angled trapezoid is located at the deepest part of the single dovetail groove.

20. The cabinet according to claim 19 wherein the long base, the right-angle side, and the hypotenuse of the right-angled trapezoid of the single dovetail tenon respectively fit the long base, the right-angle side, and the hypotenuse of the right-angled trapezoid of the single dovetail groove.

21. The cabinet according to claim 17, wherein each of the second panels has at an opposite end thereof a single dovetail groove disposed in a side surface of the second panel.

22. The cabinet according to claim 21 further including a third panel disposed parallel to the first panel and having respective end dovetail tenons engageable with respective facing single dovetail grooves of the respective pair of second panels.
